(19) United States
(12) Patent Application Publication
(10) Pub. No.: US 2026/0221003 A1
(43) Pub. Date: Jul. 30, 2026

(54) SYSTEMS AND METHODS OF LENDING OUT NON-FUNGIBLE TOKENS (NFTS) IN GAMES OF CHANCE USING SMART CONTRACTS

(71) Applicant: IGT, Las Vegas, NV (US)

(72) Inventors: Michael Russ, Graz (AT); Soheil Latifi, Brampton (CA); Sven Aurich, Schwanberg (AT); Stefan Keilwert, St. Josef (AT); Gaurav Jariwala, Halifax (CA); David Small, Moncton (CA)

(21) Appl. No.: 19/037,153

(22) Filed: Jan. 25, 2025

(51) Int. Cl. G07F 17/32

(52) U.S. Cl. CPC G07F 17/3251; G07F 17/3227

(57) ABSTRACT

Embodiments of the present disclosure are directed to the use of a Non-Fungible Token (NFT) owned by one entity but loaned to and used in the electronic game by another entity according to certain terms and while the original entity maintains ownership of the NFT. The terms for using the NFT, including restrictions on it’s use, benefits provided to the owner for the NFT’s use, and others can be written to an electronic contract. The electronic contract can be stored in a blockchain which can be provided to a gaming system. When the gaming system executes the electronic game for the entity using the NFT, the gaming system can apply the terms for use of the NFT in the game.

### BACKGROUND

The present disclosure is generally directed to the use of Non-Fungible Tokens (NFTs) in electronic games and more particularly to the use of an NFT owned by one entity but used in the electronic game by another entity.

Non-Fungible Tokens (NFTs) can be used in games to customize or personalize the game. For example, the NFT can represent a special symbol or character that can be inserted into the game or used to substitute an element of the game. In some cases, the NFT may provide enhanced winnings or other benefits when used in the game. However, current systems and methods for using NFTs within electronic games limit their used only to the owner of that NFT.

### BRIEF SUMMARY

Embodiments of the present disclosure are directed to the use of a Non-Fungible Token (NFT) owned by one entity but loaned to and used in the electronic game by another entity according to certain terms and while the original entity maintains ownership of the NFT. According to one embodiment, a method for using an NFT in an electronic game can comprise generating the NFT. The NFT can be owned by a first entity of a plurality of entities, can be usable within the electronic game, and can provide a benefit related to the electronic game when used in the electronic game. A request to allow a second entity of the plurality of entities to use the NFT in the electronic game can be received and terms for the use of the NFT in the electronic game by the second entity while the first entity maintains ownership of the NFT can be defined. The terms for the use of the NFT in the electronic game by the second entity can be written into an electronic contract controlling use of the NFT in the electronic game. The electronic contract can be stored in a blockchain associated with the NFT and the NFT and the blockchain associated with the NFT can be provided to a gaming system executing the electronic game.

The terms for the use of the NFT in the electronic game can define a restriction on the use of the NFT in the electronic game by the second entity. For example, the restriction can comprise a time limit for use of the NFT in the electronic game by the second entity. Additionally, or alternatively, the restriction can comprise a restriction on the benefit related to the electronic game.

The terms for the use of the NFT in the electronic game can additionally, or alternatively, define a benefit for the first entity for the use of the NFT in the electronic game by the second entity. For example, the benefit for the first entity can comprise a financial benefit for the first entity. In such cases, the financial benefit for the first entity can be based on a result of the electronic game. Additionally, or alternatively, the terms for the use of the NFT in the electronic game can define a benefit for a provider of the electronic game.

According to another embodiment, a system can comprise a processor and a memory coupled with and readable by the processor. The memory can store therein a set of instructions which, when executed by the processor, causes the processor to generate an NFT. The NFT can be owned by a first entity of a plurality of entities, can be usable within an electronic game, and can provide a benefit related to the electronic game when used in the electronic game. The instructions can further cause the processor to receive a request to allow a second entity of the plurality of entities to use the NFT in the electronic game, define terms for the use of the NFT in the electronic game by the second entity while the first entity maintains ownership of the NFT, write the terms for the use of the NFT in the electronic game by the second entity into an electronic contract controlling use of the NFT in the electronic game, store the electronic contract in a blockchain associated with the NFT, and provide the NFT and the blockchain associated with the NFT to a gaming system executing the electronic game.

For example, the first entity and the second entity can comprise players of the electronic game. In another example, the first entity can comprise a provider of the electronic game and the second entity can comprise a player of the electronic game. In such cases, the NFT can comprise one of a plurality of NFTs owned by the provider of the electronic game and available for use by a plurality of players of the electronic game.

In some cases, the request to allow the second entity of the plurality of entities to use the NFT in the electronic game can be received from a gaming system executing the electronic game and can be based on a win in the electronic game by a first player of the plurality of players.

Additionally, or alternatively, the terms for the use of the NFT in the electronic game can define a restriction on the use of the NFT. In such cases, the restriction on the use of the NFT can comprise automatically transferring use of the NFT to a third entity when the restriction applies.

According to yet another embodiment, a system can comprise a communications network and a gaming system coupled with the communications network. The gaming system can comprise a processor and a memory coupled with and readable by the processor of the gaming system. The memory of the gaming system can store therein a set of instructions which, when executed by the processor of the gaming system, causes the processor of the gaming system to execute an electronic game.

The system can further comprise an NFT management system coupled with the communications network. The NFT management system can comprise a processor and a memory coupled with and readable by the processor of the NFT management system. The memory of the NFT management system can store therein a set of instructions which, when executed by the processor of the NFT management system, can cause the processor of the NFT management system to generate an NFT. The NFT can be owned by a first entity of a plurality of entities, can be usable within the electronic game executed by the gaming system, and can provide a benefit related to the electronic game when used in the electronic game.

The instructions stored in the memory of the NFT management system can further cause the processor of the NFT system to receive a request to allow a second entity of the plurality of entities to use the NFT in the electronic game, define terms for the use of the NFT in the electronic game by the second entity while the first entity maintains ownership of the NFT, write the terms for the use of the NFT in the electronic game by the second entity into an electronic contract controlling use of the NFT in the electronic game, store the electronic contract in a blockchain associated with the NFT, and provide the NFT and the blockchain associated with the NFT to the gaming system executing the electronic game.

The instructions stored in the memory of the gaming system can further cause the processor of the gaming system to use the NFT in the electronic game based on the terms for use of the NFT when the second entity plays the electronic game. For example, the electronic game can comprise a slots game and use of the NFT in the slots game can comprise replacing a symbol in the slots game with the NFT. In such cases, the terms for the use of the NFT in the electronic game can further define a result for a spin in which the NFT stops on a payline of the slots game. In another example, the electronic game can comprise a video poker game and use of the NFT in the video poker game can comprise replacing a card in the video poker game with the NFT. Additionally, or alternatively, the terms for the use of the NFT in the electronic game can define a result for a win in the electronic game when the NFT is used on the electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary gaming environment in which embodiments of the present disclosure may be implemented.

FIG. 2 is a block diagram illustrating additional details of components of an exemplary Non-Fungible Token (NFT)management system according to one embodiment of the present disclosure.

FIG. 3 is a block diagram illustrating additional details of components of an exemplary gaming system according to one embodiment of the present disclosure.

FIG. 4 is a flowchart illustrating an exemplary process for using NFTs in an electronic game according to one embodiment of the present disclosure.

FIG. 5 is a flowchart illustrating an exemplary process for using NFTs in an electronic game according to another embodiment of the present disclosure.

### DETAILED DESCRIPTION

Embodiments of the present disclosure are directed to the use of a Non-Fungible Token (NFT) owned by one entity but loaned to and used in the electronic game by another entity according to certain terms and while the original entity maintains ownership of the NFT. The terms for using the NFT, including restrictions on it’s use, benefits provided to the owner for the NFT’s use, and others can be written to an electronic contract. The electronic contract can be stored in a blockchain which can be provided to a gaming system. When the gaming system executes the electronic game for the entity using the NFT, the gaming system can apply the terms for use of the NFT in the game.

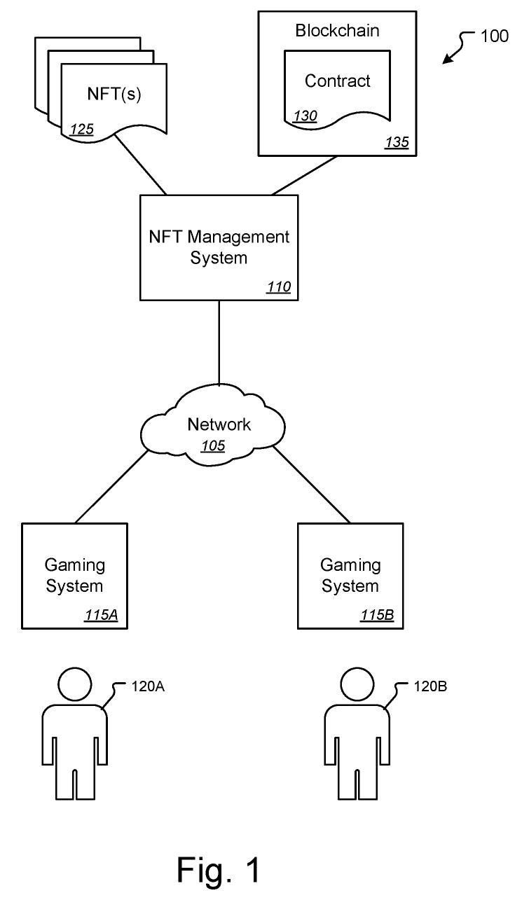

FIG. 1 is a block diagram illustrating an exemplary gaming environment in which embodiments of the present disclosure may be implemented. As illustrated in this example, the environment 100 can comprise a communications network 105 and an NFT management system 110 coupled with the communications network 105. The NFT management system 110 can comprise any one or more servers and/or other computing devices as known in the art. The communications network 105 can comprise any one or more wired and/or wireless, local-area and/or wide-area networks as known in the art including, but not limited to, the Internet.

One or more gaming systems 115A and 115B can also be coupled with the communications network 105. Each gaming system 115A-115B can comprise, for example, any Electronic Gaming Machine (EGM), kiosk, or similar gaming system as may be found in a casino or other gaming venue. The gaming systems 115A-115B can each execute any of a variety of electronic games including, but not limited to slots, video slots, video poker, keno, etc. to be played by one or more players 120A and 120B.

According to embodiments of the present disclosure, the NFT management system 110 can generate NFTs 125 such as symbols, cards, characters, etc. for use in electronic games. The NFTs 125 can be owned by a first entity, e.g., a player 120A, an operator of the electronic game, an owner or operator of a casino or gaming venue in which the gaming system is operating, etc. can be usable within electronic games executed by the gaming systems 115A-115B, and can provide a benefit related to the electronic game when used in the electronic game, e.g., enhanced winnings etc.

Generally speaking, the NFT management system 110 can receive a request to allow a second entity, e.g., another player 120B, to use an NFT 125 in the electronic game. The request can be received from a gaming system 115A, from the entity owning the NFT through another device or system, etc. The NFT management system 110 can define terms for the use of the NFT 125 in the electronic game by the second entity while the first entity maintains ownership of the NFT 125, write the terms for the use of the NFT 125 in the electronic game by the second entity into an electronic contract 130 controlling use of the NFT 125 in the electronic game, store the electronic contract 130 in a blockchain 135 associated with the NFT 125, and provide the NFT 125 and the blockchain 135 associated with the NFT to the gaming system executing the electronic game. The gaming system 115A can then use the NFT 125 in the electronic game based on the terms for use of the NFT 125 when the second entity plays the electronic game.

Stated another way, embodiments described herein include the use of NFTs within games of chance which grant the NFT-using player additional benefits within the game, be it benefits that are financial, potentially financial, or financial in a broader sense. Use of these NFTs and the associated benefits can be subject to some restrictions such as limited use, limited use per time period, reduction in the potential maximum win achieved through the NFT etc.

NFTs, owned by a first person or entity, i.e., the owner, can be lent out by another person, i.e., the borrower, such as for a limited time. The first person or entity would still remain the owner of the NFT, but during the lent-out time, borrower would be permitted to use it and (potentially) benefit from it.

The benefit for borrower can be an in-game benefit through the lent-out NFT without requiring owning the NFT, as such NFTs might be extremely expensive. In return, there can be a benefit for the owner such as a “lend out fee” paid by borrower and/or a “win participation” based on what the borrower achieved through use of the NFT. According to one embodiment, the game provider, e.g., a casino operator and/or a game manufacturer, can benefit from this system through a percentage-share of each transaction made with that NFT between two people.

In another embodiment, the owner may pay a borrower for using their NFT such as when the NFT is evolving, making progress, or becoming more valuable the more the NFT is used.

According to one embodiment, the details for transaction fees, lend out fees, win participation fees, etc. can be stored in the electronic contract 130 stored in the blockchain 135 associated with the NFT 125. These details might either be defined by the NFT creator, e.g., casino operator or game manufacturer, or by the NFT owner.

The fees could be dynamic and based on factors such as X % per transaction, X $ per transaction, depending on the lend out time, depending on the potential value it might provide the user, e.g., what feature it enables and/or what the jackpot prize is, etc., depending on the historical value it has provided to users in the past, depending on its availability, e.g., number of remaining uses, number of max. activations per day, etc.

For example, in a poker game, a card can be replaced with the one that is represented by the NFT. In a slot game, the NFT can be used to replace a symbol, re-spin a reel, add one scatter symbol, etc. In a slot game, based on a result with the NFT, the game can grant a free spin, add a number of free spins within a free spin bonus, add a number of picks in pick a feature, etc. A potential win in any game can be affected based on use of the NFT such as “If I win within the next 5 Bets, triple my win” or “If I win the jackpot tonight, double it” etc.

In the scenario described above, where the owner might pay the borrower to play with ther NFT, benefits could be such as in a poker game, the NFT can replace a card, and the NFT starts representing a “2” which grants the lowest chance for high wins. By playing some number of poker hands with the NFT activated, it could evolve to a “3” and so on, all the way up to an “Ace.”

It could also be that the NFTs value is player selectable, e.g., initially, only a “2.” But when it has evolved to a “3” it can either be used as “2” or “3.” When is has evolved to a “4” it can also be a “4”, etc.

In a slot game, the NFT may start as having no functionality. But after reaching “level 1” it could replace 1 symbol. After evolving to “level 2” it could replace a whole reel, etc. Based on the terms written into the electronic contract, the borrower would not be eligible to use the NFT’s functionality, however as they just lent it out to evolve it further for the owner.

According to one embodiment, an NTF online exchange can be provided by the NFT management system 110 in which players can trade special NTFs. For example, a player can sell, buy, or change NFTs. In this case the card continually change owner. In another example, a player can rent the NFTs for a fixed value. In this case the NFT changes the owner for a certain period or number of uses. In some cases, the NFT can be bought and sold like in an auction. Different kinds of auctions are possible such as American style, Netherlands style, etc. In some cases, an operator or game provider can get shares from each deal done through the exchange or marketplace and the player gets security from the operator or game provider.

According to one embodiment, an NFT rent fee can be charged for poker cards in which the owner receives compensation for lending out NFT used as the poker card. As noted above, the lending can be described in the electronic contract which contains a description of the compensation agreement. If multiple NFTs/cards of the same owner are lent out, additional perks might get activated, such as reduced lending fees as defined in the electronic contract.

According to one embodiment, the compensation defined in the electronic contract can be a static compensation. For example, this static compensation can be defined as a fixed amount per time-unit, e.g., daily fee, a fixed amount per x-time usage, an upfront payment or payment at NFT return to the owner. In such cases the borrower can provide/lock reserves for borrowing in the moment he lends out the NFT to guarantee lending fees for the lender. According to another embodiment, the compensation defined in the electronic contract can be a dynamic compensation such as a percentage cut of wins made whenever the lent card was part of the winning hand. According to yet another embodiment, the compensation defined in the electronic contract can be a combination of fixed and dynamic fees

According to one embodiment, a casino operator can offer a pool of NFTs for players to use to enable benefits/privileges. In such cases, the NFTs may be distributed on a first come first served basis or based on other rules, e.g., player tier level etc. The NFT Pool might be refreshed on a recurring basis, e.g., weekend, start of a new month, event in the casino etc.

According to one embodiment, players can lend out NFTs which can be charged up, time limited, or restricted in other ways. Such NFTs may enable promotional play, enable discounts within the casino, allow access, activate enhanced collection of player loyalty points etc.

Additionally, or alternatively, upon occurrence of defined criteria or events, the lent NFT can be automatically returned to the owner, as specified in the electronic contract. For example, when the borrowing time has expired, charges were used up, the NFT wasn´t used within a defined time-frame, etc., the use of the NFT by the borrower can be terminated.

According to one embodiment, use of the NFT can automatically change to another person upon the occurrence of an event. For example, when someone wins the jackpot, that person can be give use of the NFT for a limited period or until someone else wins the jackpot. In some cases, the ultimate NFT can then be sold by the end of the year.

According to one embodiment, a printable NFT can be provided for limited use. For example, players can have the cards printed for table games and have them shredded once the game is played.

In some cases, an NFT may confer governance rights within the gaming platform. For example, the player can use the NFT to participate in decision making processes such as voting on rules changes, theme changes, and more.

According to one embodiment, the use defined in the electronic contract could be between two players (A to B) or the NFT could be loaned out to multiple players sequentially or simultaneously resulting in a one-to-multi player contract, e.g., A to B and C and D, …, etc. In the case of multi-users using the token simultaneously, a private jackpot or progressive could be created for those players renting the NFT, and in some cases including the owner as well. At the end of a fixed time or end of a group play session, one of the live users could win the jackpot, or it could be carried over.

According to one embodiment, borrowers can pay to further enhance capabilities of token. For example, borrowers can purchase additional temporary features or enhancements to the token. The borrower would enjoy the benefits of enhanced features during the rental period. In some cases, borrowers can purchase permanent enhancement to the NFT so that the borrower would enjoy the enhanced features on subsequent rents. The borrower could also get a discount on the next rental. The owner could also enjoy the benefits of the enhanced NFT. T he enhanced features could drive up the rental price for other borrowers.

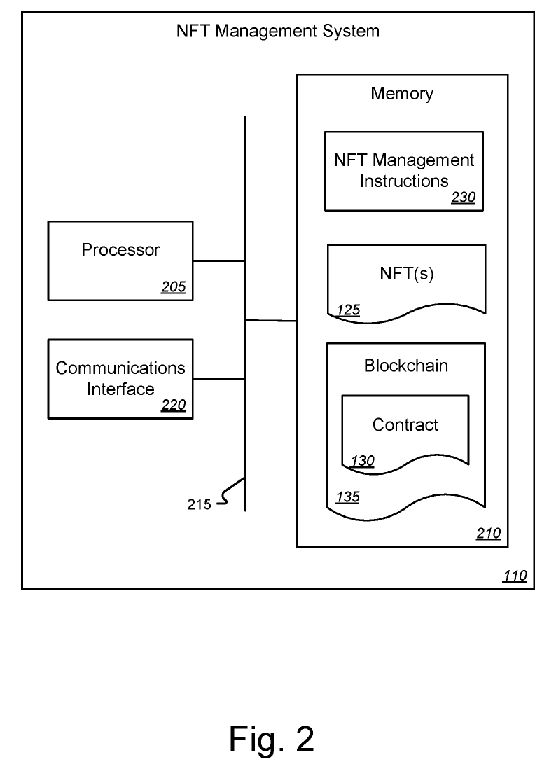

FIG. 2 is a block diagram illustrating additional details of components of an exemplary Non-Fungible Token (NFT) management system according to one embodiment of the present disclosure. As illustrated in this example, the NFT management system 110 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the NFT management system 110 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215 and one or more sensors 225. The communication interface(s) 220 can comprise, for example, an Ethernet, Bluetooth, WiFi, cellular, and/or other type of wired and/or wireless communications interface. Via the communication interface(s) 220, the NFT management system 110 can communicate with other devices and/or systems through a communications network 105 as described above.

The memory 210 can store therein a set of NFT management instructions 230 which, when executed by the processor 205, cause the processor 205 to generate an NFT 125. The NFT 125 can be owned by a first entity of a plurality of entities, can be usable within an electronic game, and can provide a benefit related to the electronic game when used in the electronic game. The NFT management instructions 230 can further cause the processor 205 to receive, through the communications interface 220, a request to allow a second entity of the plurality of entities to use the NFT 125 in the electronic game, define terms for the use of the NFT 125 in the electronic game by the second entity while the first entity maintains ownership of the NFT 125, write the terms for the use of the NFT 125 in the electronic game by the second entity into an electronic contract 130 controlling use of the NFT 125 in the electronic game, store the electronic contract 130 in a blockchain 135 associated with the NFT 125, and provide the NFT 125 and the blockchain 135 associated with the NFT 125 to a gaming system 115A executing the electronic game.

The terms for the use of the NFT in the electronic game can define a restriction on the use of the NFT in the electronic game by the second entity. For example, the restriction can comprise a time limit for use of the NFT in the electronic game by the second entity. Additionally, or alternatively, the restriction can comprise a restriction on the benefit related to the electronic game.

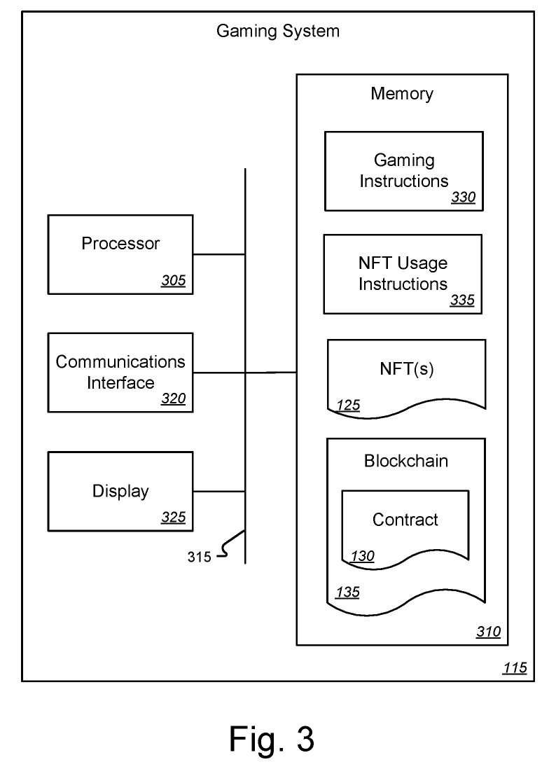

FIG. 3 is a block diagram illustrating additional details of components of an exemplary gaming system according to one embodiment of the present disclosure. As illustrated in this example, a gaming system 115 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, and a display 325. The communication interfaces 320 can comprise, for example, an Ethernet, Bluetooth, WiFi, cellular, and/or other type of wired and/or wireless communications interface. The display 325 can comprise a Liquid Crystal Display (LCD), Light Emitting Diode (LED), Organic Light Emitting Diode (OLED), or other type of display.

The memory 310 can store therein a set of gaming instructions 330 which, when executed by the processor 305, causes the processor 305 to execute an electronic game. The memory 310 can store therein a set of NFT usage instructions 335 which, when executed by the processor 305, causes the processor 305 to request the NFT 125 and receive the NFT 125 and a blockchain 135 associated with the NFT 125 from the NFT management system 110 through the communications interface 320. In other cases, the NFT usage instructions 335 can cause the processor 305 to receive the NFT 125 and blockchain 135 without first requesting the NFT 125.

In either case, once the NFT 125 is received 510, the NFT usage instructions 335 can cause the processor 305 to read the terms for use of the NFT from an electronic contract 130 stored in the blockchain 135. The NFT usage instructions 335 can cause the processor 305 to use the NFT 125 in the game according to the terms.

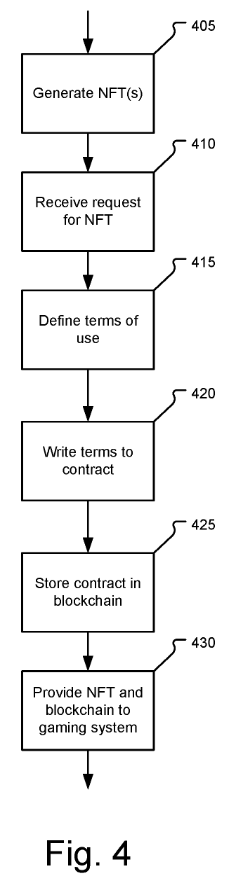

FIG. 4 is a flowchart illustrating an exemplary process for using NFTs in an electronic game according to one embodiment of the present disclosure. More specifically, this example illustrates processes as may be performed by the NFT management system 110 as described above. As illustrated in this example, using an NFT 125 in an electronic game can comprise generating 405 the NFT 125. The NFT 125 can be owned by a first entity of a plurality of entities, can be usable within the electronic game, and can provide a benefit related to the electronic game when used in the electronic game. A request to allow a second entity of the plurality of entities to use the NFT 125 in the electronic game can be received 410 and terms for the use of the NFT in the electronic game by the second entity while the first entity maintains ownership of the NFT can be defined 415.

For example, the first entity and the second entity can comprise players of the electronic game. In another example, the first entity can comprise a provider of the electronic game and the second entity can comprise a player of the electronic game. In such cases, the NFT 125 can comprise one of a plurality of NFTs owned by the provider of the electronic game and available for use by a plurality of players of the electronic game.

In some cases, the request to allow the second entity of the plurality of entities to use the NFT 125 in the electronic game can be received from a gaming system executing the electronic game and can be based on a win in the electronic game by a first player of the plurality of players.

The terms for the use of the NFT 125 in the electronic game can define a restriction on the use of the NFT in the electronic game by the second entity. For example, the restriction can comprise a time limit for use of the NFT 125 in the electronic game by the second entity. Additionally, or alternatively, the restriction can comprise a restriction on the benefit related to the electronic game.

The terms for the use of the NFT 125 in the electronic game can additionally, or alternatively, define a benefit for the first entity for the use of the NFT in the electronic game by the second entity. For example, the benefit for the first entity can comprise a financial benefit for the first entity. In such cases, the financial benefit for the first entity can be based on a result of the electronic game. Additionally, or alternatively, the terms for the use of the NFT 125 in the electronic game can define a benefit for a provider of the electronic game.

The terms for the use of the NFT 125 in the electronic game by the second entity can be written 420 into an electronic contract 130 controlling use of the NFT 125 in the electronic game. The electronic contract 130 can be stored 425 in a blockchain 135 associated with the NFT 125 and the NFT 125 and the blockchain 135 associated with the NFT 125 can be provided 430 to a gaming system 115 executing the electronic game.

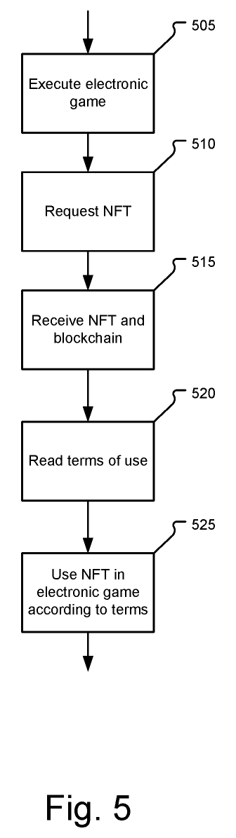

FIG. 5 is a flowchart illustrating an exemplary process for using NFTs in an electronic game according to another embodiment of the present disclosure. More specifically, this example illustrates processes as may be performed by a gaming system 115 as described above. As illustrated in this example, using an NFT 125 in the electronic game can comprise executing 505 an electronic game. At some point, for example, based on a win event in the electronic game, by request or selection of the player, etc., the NFT 125 can be requested 510 and the NFT 125 and a blockchain 135 associated with the NFT 125 can be received 515 from the NFT management system 110. In other cases, the NFT 125 and blockchain 135 may be received 510 without first being requested 505.

In either case, once the NFT 125 is received 510, terms for use of the NFT 125 can be read 520 from an electronic contract 130 stored in the blockchain 135. These terms can be applied as the NFT 125 is used 525 in the game according to the terms. For example, the electronic game can comprise a slots game and use of the NFT 125 in the slots game can comprise replacing a symbol in the slots game with the NFT 125. In such cases, the terms for the use of the NFT 125 in the electronic game can further define a result for a spin in which the NFT 125 stops on a payline of the slots game. In another example, the electronic game can comprise a video poker game and use of the NFT 125 in the video poker game can comprise replacing a card in the video poker game with the NFT 125. Additionally, or alternatively, the terms for the use of the NFT 125 in the electronic game can define a result for a win in the electronic game when the NFT 125 is used on the electronic game.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for using a Non-Fungible Token (NFT) in an electronic game, the method comprising:
generating, by a processor of an NFT management system, the NFT, wherein the NFT is owned by a first entity of a plurality of entities, wherein the NFT is usable within the electronic game, and wherein the NFT provides a benefit related to the electronic game when used in the electronic game;
receiving, by the processor of the NFT management system, a request to allow a second entity of the plurality of entities to use the NFT in the electronic game;
defining, by the processor of the NFT management system, terms for the use of the NFT in the electronic game by the second entity while the first entity maintains ownership of the NFT;
writing, by the processor of the NFT management system, the terms for the use of the NFT in the electronic game by the second entity into an electronic contract controlling use of the NFT in the electronic game;
storing, by the processor of the NFT management system, the electronic contract in a blockchain associated with the NFT; and
providing, by the processor of the NFT management system, the NFT and the blockchain associated with the NFT to a gaming system executing the electronic game.

2. The method of claim 1, wherein the terms for the use of the NFT in the electronic game define a restriction on the use of the NFT in the electronic game by the second entity.

3. The method of claim 2, wherein the restriction comprises a time limit for use of the NFT in the electronic game by the second entity.

4. The method of claim 2, wherein the restriction comprises a restriction on the benefit related to the electronic game.

5. The method of claim 1, wherein the terms for the use of the NFT in the electronic game define a benefit for the first entity for the use of the NFT in the electronic game by the second entity.

6. The method of claim 5, wherein the benefit for the first entity comprises a financial benefit for the first entity.

7. The method of claim 6, wherein the financial benefit for the first entity is based on a result of the electronic game.

8. The method of claim 1, wherein the terms for the use of the NFT in the electronic game define a benefit for a provider of the electronic game.

9. A system comprising:
a processor; and
a memory coupled with and readable by the processor and storing therein a set of instructions which, when executed by the processor, causes the processor to:
generate a Non-Fungible Token (NFT), wherein the NFT is owned by a first entity of a plurality of entities, wherein the NFT is usable within an electronic game, and wherein the NFT provides a benefit related to the electronic game when used in the electronic game;
receive a request to allow a second entity of the plurality of entities to use the NFT in the electronic game;
define terms for the use of the NFT in the electronic game by the second entity while the first entity maintains ownership of the NFT;
write the terms for the use of the NFT in the electronic game by the second entity into an electronic contract controlling use of the NFT in the electronic game;
store the electronic contract in a blockchain associated with the NFT; and
provide the NFT and the blockchain associated with the NFT to a gaming system executing the electronic game.

10. The system of claim 9, wherein the first entity and the second entity comprise players of the electronic game.

11. The system of claim 9, wherein the first entity comprises a provider of the electronic game and the second entity comprises a player of the electronic game.

12. The system of claim 11, wherein the NFT comprises one of a plurality of NFTs owned by the provider of the electronic game and available for use by a plurality of players of the electronic game.

13. The system of claim 12, wherein the request to allow the second entity of the plurality of entities to use the NFT in the electronic game is received from a gaming system executing the electronic game and is based on a win in the electronic game by a first player of the plurality of players.

14. The system of claim 12, wherein the terms for the use of the NFT in the electronic game define a restriction on the use of the NFT.

15. The system of claim 14, wherein the restriction on the use of the NFT comprise automatically transferring use of the NFT to a third entity when the restriction applies.

16. A system comprising:
a communications network;
a gaming system coupled with the communications network, the gaming system comprising a processor and a memory coupled with and readable by the processor of the gaming system and storing therein a set of instructions which, when executed by the processor of the gaming system, causes the processor of the gaming system to execute an electronic game; and
a Non-Fungible Token (NFT) management system coupled with the communications network, the NFT management system comprising a processor and a memory coupled with and readable by the processor of the NFT management system and storing therein a set of instructions which, when executed by the processor of the NFT management system, cause the processor of the NFT management system to:
generate an NFT, wherein the NFT is owned by a first entity of a plurality of entities, wherein the NFT is usable within the electronic game executed by the gaming system, and wherein the NFT provides a benefit related to the electronic game when used in the electronic game;
receive a request to allow a second entity of the plurality of entities to use the NFT in the electronic game;
define terms for the use of the NFT in the electronic game by the second entity while the first entity maintains ownership of the NFT;
write the terms for the use of the NFT in the electronic game by the second entity into an electronic contract controlling use of the NFT in the electronic game;
store the electronic contract in a blockchain associated with the NFT; and
provide the NFT and the blockchain associated with the NFT to the gaming system executing the electronic game and wherein the instructions stored in the memory of the gaming system further cause the processor of the gaming system to use the NFT in the electronic game based on the terms for use of the NFT when the second entity plays the electronic game.

17. The system of claim 16, wherein the electronic game comprises a slots game and wherein use of the NFT in the slots game comprises replacing a symbol in the slots game with the NFT.

18. The system of claim 17, the terms for the use of the NFT in the electronic game further define a result for a spin in which the NFT stops on a payline of the slots game.

19. The system of claim 16, wherein the electronic game comprises a video poker game and wherein use of the NFT in the video poker game comprises replacing a card in the video poker game with the NFT.

20. The system of claim 16, wherein the terms for the use of the NFT in the electronic game define a result for a win in the electronic game when the NFT is used on the electronic game.
